(19) United States
(12) Patent Application Publication
(10) Pub. No.: US 2015/0309993 A1
(43) Pub. Date: Oct. 29, 2015

(54) Agile Enterprise Globalization

(71) Applicant: Jeffrey Charles Wilde, Los Gatos, CA (US)

(72) Inventor: Jeffrey Charles Wilde, Los Gatos, CA (US)

(21) Appl. No.: 14/696,243

(22) Filed: Apr. 24, 2015

Related U.S. Application Data
(60) Provisional application No. 61/983,668, filed on Apr. 24, 2014.

(51) Int. Cl. G06F 17/28; G06F 17/22; G06F 17/30; H04L 29/08; G06F 3/0484

(52) U.S. Cl. CPC G06F 17/28; H04L 67/02; G06F 3/0484; G06F 17/30887; G06F 17/2247

(57) ABSTRACT

Software globalisation is the process of creating a version of the underlying software that is meant for consumption in another country. Companies typically do this by first going through a costly and cumbersome development stage where the programmers manually separate all the text from the rest of the screens, set them aside in ‘resource’ files and write code to retrieve those strings one at a time. Only then can the resource files be given to human translators to translate and the reintegration and preview process of those files is slow and difficult. The present invention is a system that renders the screens of an application ‘editable’ so that globalization professionals can make their translations and other market-specific alterations directly on the screens themselves, completely bypassing this stage of developer preparation, and enabling an immediate preview, and live release, of those changes. It can also do this without resorting to localization proxy servers, a technique emerging recently that to some degree eliminates the coding stage of software globalization, but that forces a cached view of the page and thereby limits the practicality of such a no-coding approach.

### CROSS-REFERENCE AND PRIORITY CLAIM TO RELATED APPLICATIONS

To the fullest extent permitted by law, the present patent cooperation treaty application claims priority to and the full benefit of provisional patent application entitled “Agile Enterprise Globalization”, filed on Apr. 26, 2014 (Prior application No. 61/983,668

### FIELD OF THE INVENTION

The present invention relates generally to the software globalization process. More specifically, it relates to agile, in-the-cloud software globalization.

### BACKGROUND OF THE INVENTION

### Agile Enterprise Globalization-Software Globalization Background

Software globalization is the process of creating a version of the underlying software that is meant for consumption in another market. Primarily, the language in a screen or page is translated, but also dates and numbers are formatted, currency sometimes converted, font styles adjusted, different images displayed, components excluded or included etc. The result is that the user interface, or screens of a software application appear appropriately to someone in another country.

### Traditional Software Globalization Background

This process of globalization of a website, native “client” application or mobile application has traditionally been cumbersome and labor-intensive. Software developers must essentially locate each element of the software that needs to be changed in the new market and write code—at least one line of code per element, usually more, to make the adjustments. For example, a piece of text (called a string in the industry) such as “See more products like this”, is typically extracted manually, put into a “resource” file (or other data store) and then referenced in a line of code which is also created manually Then many copies of that resource file are made representing each language and the code decides after it has determined which market to display, which resource file to draw from. The resource file is given out to translators, which then perform their translations and send back their versions, at which point the new resource files can be integrated into the software project. In the case of a website, the project must be compiled with the new resource files and then re-deployed onto the servers in a web farm before the translators, or anyone else can see the results on the website of those translations. Different companies use different techniques and the data stores can go by different names other than “Resource Files”, but the core process is usually similar: globalization information is held in a data store, accessed by voluminous lines of manually-written code, and require at least a deployment, and usually also a build (compilation) of the underlying software.

### Agile Globalization Background

There is a new way to go about this that has recently been emerging, which this paper will refer to as “Agile Globalization”. Some pieces of this approach are already being employed in the industry. But the approach in its current state is limited in many ways. The inventions detailed in this paper greatly expand the power, reach, simplicity and performance of the Agile Globalization paradigm.

Agile Globalization, in a nutshell is the practice of globalizing a software application such as a website without having to write any code to do so. This gist is this: As a website owner and customer of an Agile Globalization company, the user goes to a website, enters the URL of their site, and after a process of automated string extraction, the user sees all the ‘strings’, (pieces of text) that exist in the website. Then the user's translators translate them. The user can see a preview of what the website looks like with the newly translated strings. The user clicks ‘Publish’ and web page queries going to international domain versions of the user's site, i.e. www.yoursite.it appear in the translated language.

By using this approach, no custom coding need be written to globalize a website, client application or mobile application. As a result the process is dramatically more simple, cheap and quick to launch. The key elements of this technique are:

1. In The Cloud: The globalisation information is held in the cloud, in a central database.
2. String Extraction: The strings (segments of text) are scanned and automatically identified from the within the UI and stored in the central database.
3. Proxy Servers. The Localization Proxy Server (LPS) intercepts requests to the web server that normally serve up the page. If a globalized version of that page is not found in cache, then the request passes through to another Translation Server, typically owned by a Globalization Specialty Company (GSC), which in turn hits the Origin Server of a client of the GSC, to get the source html, and then globalizes it by extracting the strings and replacing them. The Translation Server sends the page on to the LPS, which caches it for future requests.
4. A Globalization Management Application (GMA) provides a place online where users can translate the extracted strings, and perform other marketization manipulation such as the conditional display of images or of segments of a screen, without writing any custom code.
This approach is a vast improvement over the old system, but still has serious limitations. Those limitations stop it from being able to be leveraged in highly dynamic, user-aware, timely display, or client-side web application environments. It also is difficult to leverage in environments that have enterprise-level marketization requirements.
a. Localization Proxy Servers (LPS)
Localization Proxy Servers (LPS), also known as “Translation Proxy Servers” are a system in which a program resides on a remote server outside of the machine rendering the webpage, and typically outside of the network of the client company and controlled by the same central company that controls the cloud database. When the request is made to the primary/origin servers for a website page, that request is routed through the localization proxy server, which intercepts the request, queries the origin server for the html, converts it to the globalized version and then returns it to the user. Typically these servers then cache that request so when it comes in again, they can return the cached output immediately, which has been stored in RAM on the LPS and do not have to query the origin servers again, which would be far too slow to be acceptable for every page query, taking typically between 1-3 full seconds.
The system is very similar, if not tantamount to, an “edge-caching” or “content delivery” network.
A diagram can be seen in FIG. 1 of the existing Localization Proxy Server approach.

### Limitations of LPSs

This approach has the advantage that a website can be localized without getting engineers of the client company involved, and in fact without ever even touching the web servers on which that website is localized. However, it has the disadvantage that it cannot handle diverse and highly dynamic web pages because what it cannot cache in whole, i.e. as an entire page, it cannot service in a reasonably timely manner.

### LPS—Shopping Cart Example

Take for example a simple shopping cart page. That page shows different contents for different users at different times. The user simply cannot cache that page in its entirety, because it is always changing. In that instance the user needs to query the origin servers to find out what is in a given user's shopping cart at this moment. No previously cached version of that shopping cart page can give the user any assurance of what the shopping cart contains at this moment. Again, it is important to remember that the LPS is only capable of caching a page in its entirety, and cannot simply retrieve the data of the website and apply it to a known html template. Even if it could do this, the performance would be no better than that of retrieving the entire page with a server-to-server call.
So using the LPS technique for this shopping cart example, the proxy server must, for every single request that goes to it, perform the same original server-to-server call from the proxy server to the origin server to get the page's output, alter it, and then send it on its way. However, that option poses a performance problem. A typical client company will try to keep its server-side performance of a shopping cart down to 500 milliseconds or less, but this solution will add typically 1-3 full seconds to the page load wait time, which is unlikely to be perceived well by the client company, i.e. the company seeking to use the Globalization Cloud company's globalization services. In most cases it will be considered unacceptable.

This dilemma is not limited only to shopping carts of course but to any page that is dynamic in that way, particularly any page which has user information on it, such as

All the pages of a checkout process of a logged in user

A home page that has a “Hello Joe” greeting on it

A page which has a user-built list

A page with many potential permutations, such as a search results screen

Any website page that needs to be updated every few minutes to display time sensitive information, such as a financial website or a microblogging site such as Twitter.

Any website with user-generated content, where the frequency with which the users can update the content, and where that content is expected to appear on the site, is in the order of minutes.

The LPS technique would also not be able to be widely leveraged for websites that are largely client-side, as websites today are increasingly becoming, because these applications do not query pages in their entirety, and because a lot of html assembly and rendering are handled on the client.

A company employing a LPS would have to either accept an extremely long delay for such pages, or to abandon the Agile Globalization technique for those pages and revert essentially to the traditional, manually programmed technique for them, while directing the LPCs to always pass through to the origin servers in those cases. Not only would this undermine the no-coding underlying objective of the Agile Globalization approach all together, but it would create a large maintenance hassle in managing the globalization of those pages as they are refined and redesigned moving forward.

### BRIEF DESCRIPTION OF THE DRAWINGS

FIG. 1 is a diagram depicting the physical architecture and flow of ‘localization proxy servers’, a limited technique used in the industry today to enable website globalization without developer-intensive programming preparation

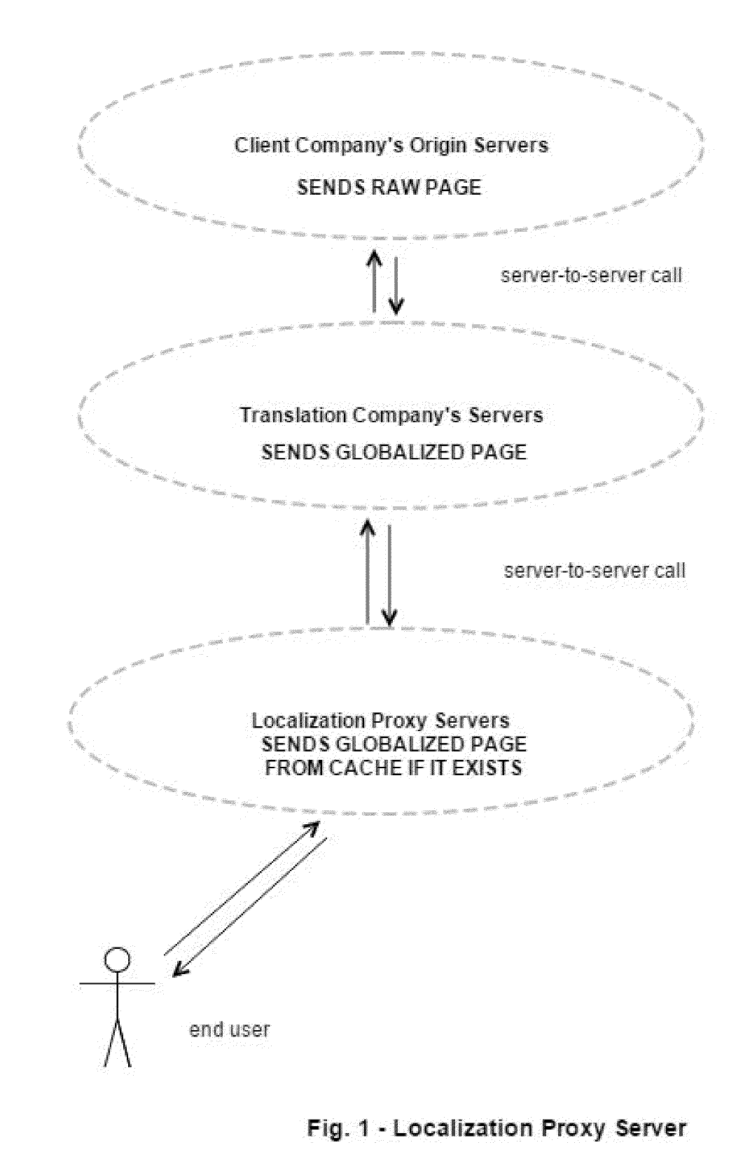

FIG. 2 is a diagram depicting the physical architecture and flow of the “Onsite Global Runtime Converter (GRC)” system.

FIG. 3 is a diagram depicting the physical architecture and flow of the Multiserver RAM Refresh component of the present invention

FIG. 4 is a flowchart diagram of the Masks component of the present invention.

FIG. 5 is a diagram depicting the physical architecture and flow of the Segment Control component of the present invention.

FIG. 6 is a diagram depicting the physical architecture and flow of an Image Control and Transferring method of the present invention.

FIG. 7 is a diagram depicting the physical architecture and flow of the IGMA component of the present invention.

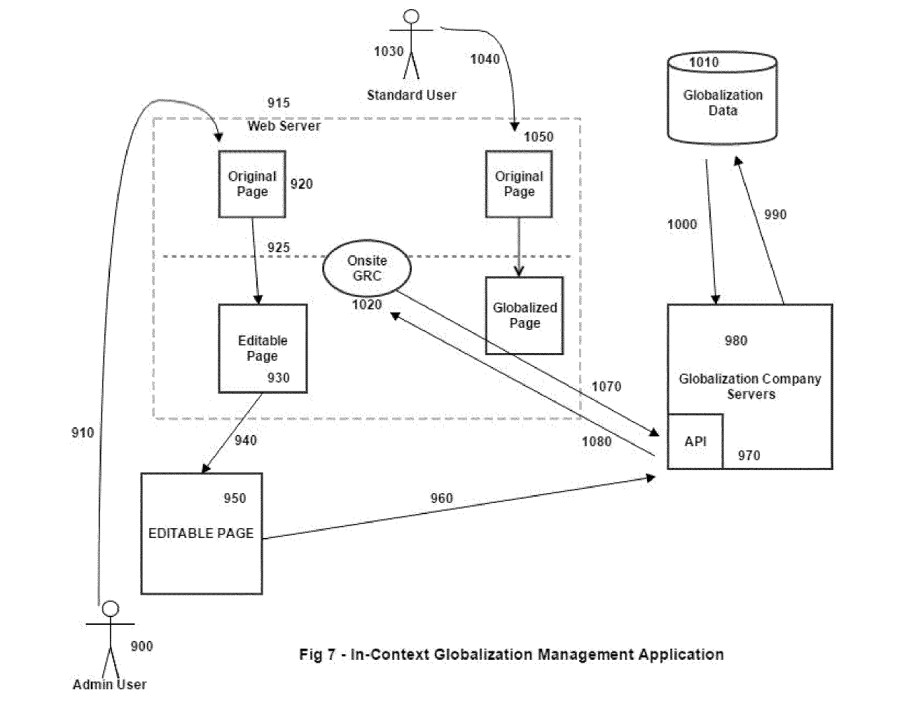

FIG. 8 is a set of screenshots from an example user interface of the IGMA system component of the present invention.

FIG. 9 is a screenshot from an example user interface of the IGMA system component of the present invention.

### DETAIL DESCRIPTIONS OF THE INVENTION

All illustrations of the drawings are for the purpose of describing selected versions of the present invention and are not intended to limit the scope of the present invention.

### The Proposed Invention: Agile Enterprise Globalization

Below are the set of interlocking techniques proposed in this paper which break these barriers and bring the Agile Globalization paradigm to the next level and into the world of robust and modem enterprise software. I am calling this system Agile Enterprise Globalization:

1. Onsite Global Runtime Converter (OGRC or GRC) This set of inventions allows the program performing the globalization conversion to reside on the device doing the rendering, eliminating the Proxy Server system along with its limitations. This in turn opens up a new world of dynamic software applications that can participate in Agile Globalization.

2. Advanced String Extraction and Segment Control This allows not only the strings, but any other element on a screen to be manipulated without writing code, which is typically demanded in the ‘marketization’ component of globalization.

3. Inline Globalization Management Application

This invention allows the globalization changes, including the translation ones, to literally be made directly on the website, a technique which for the first time allows for a no-coding method for identifying and manipulating segments, images and other marketization-related pieces of a web page.

### I. Onsite Global Runtime Converter (Onsite GRC)

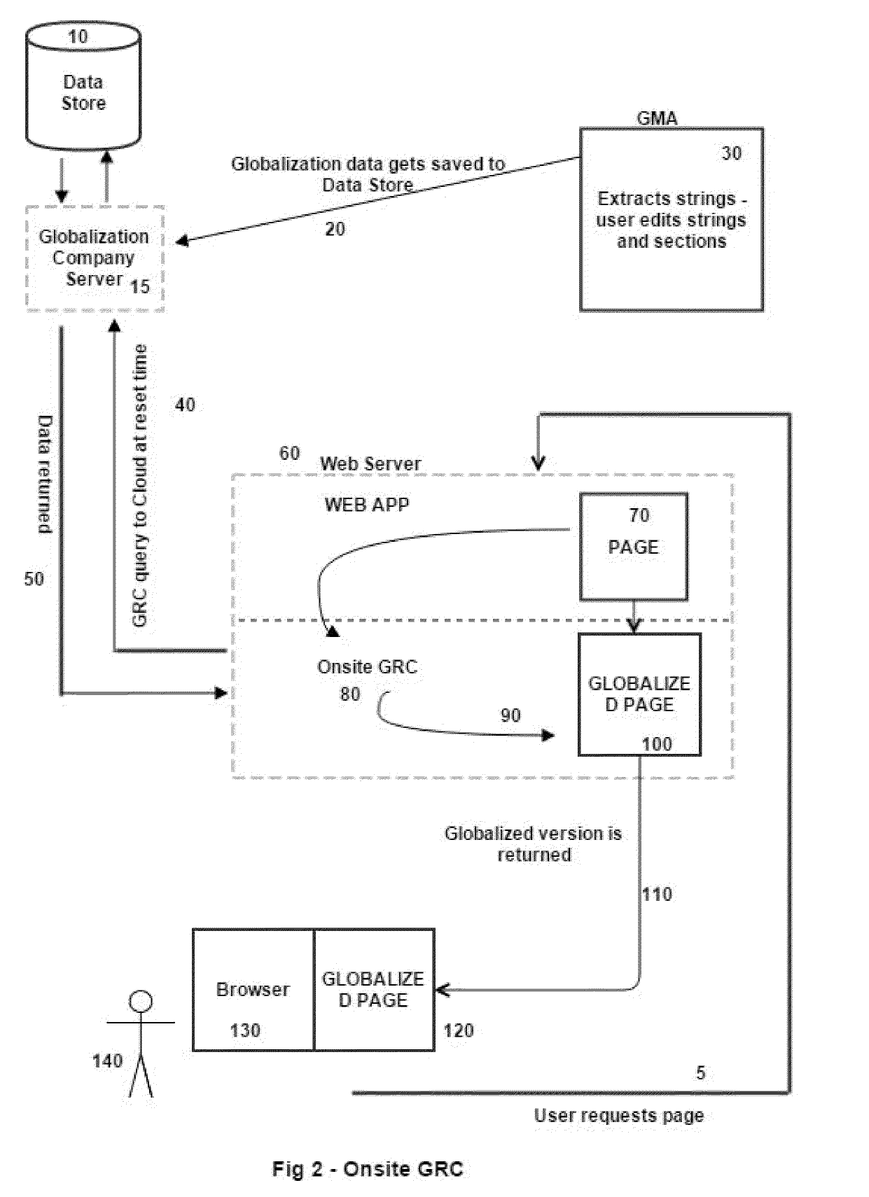

An Onsite GRC is a globalization conversion program that resides on the device in which the screen is being rendered or assembled but is still part of a system that resides ‘in the cloud’, i.e. where the globalization data is stored in a separate data store on another machine, typically a database created and managed by a separate Globalization Company. Most commonly, the device that the OGRC resides on is the webserver 60 that is rendering the web page. But it can also include a mobile device in which the screens are being rendered/assembled, or the end user's machine in which a page is being rendered or assembled in client-side script, typically JavaScript, or the end user's machine in which a screen is being rendered for a local native application (i.e. Paint, WinZip or Excel).
This description will focus on the WebServer embodiment of this invention, but after using this embodiment as an example, will talk briefly about the other embodiments as well.
In the embodiment of web pages, from FIG. 2, executable code 80 is placed on the web server 60 that renders the web pages 70. This program is referenced by a web project which is used by developers to create web pages, or by the web server software, which is software that is used on the server to render web pages, and is used in conjunction with individual web projects. This program essentially intercepts, on the same computer, the outgoing html 70 and alters it 90 for the purposes of producing the globalized web page's source markup 100, and then sends it on its way 110 to the end user's browser 130.
In one embodiment, in the .NET ‘platform’ or environment, this executable can exist as an “Isapi DLL” a executable set of computer instructions that is able to place a hook into the webserver software, evaluate data that is about to be output, alter it, and then send it on its way. Or it could exist as an ‘HttpModule’, an executable that hooks into a particular .NET project, such as an asp, asp.net or asp.net mvc application. In the .NET embodiment, an example of ‘web server software’ might be (but would not be limited to) Internet Information Server (IIS). An example of the web project might be Asp, Asp.net or Asp.net MVC. In different environments such as J2EE, LAMP, Ruby, Python, etc., there are specific types of software for each of these categories, targeted at different platforms and made by different vendors.
How does the software transform the page? That is the topic of the remainder of the description, but the summary is this: A Globalization Professional (GP) 150 uses a Globalization Management Application (GMA) 30 to extract the various bits of text from the webpage and translate them, as well as specify instructions for the handling of other parts of the page in various markets, explained in more detail below. This information is stored in a database 10. In the preferred embodiment, both the GMA and the database are maintained by the Globalization Company (GC) on their servers and not by the people that maintain the web page. This is the “cloud” implementation. In another, less preferred and less common, embodiment, the database and GMAs could be owned and maintained by the same group that owns the website, and could be hosted on the same servers. Then at a particular time, explained in more detail below, the Onsite GRC 80 queries 40 the data from the database 10 that it needs to make the globalized version of the webpage, and that data is returned to it 50. It then holds that data, preferably in random access memory (RAM), as data local to the Onsite GRC 80, held physically on the client's web server 60. This data would contain the translations for various pieces of text (known in the industry as ‘strings’), as well as other information relating to images on the webpage, sections of html, etc, and how they should be handled in various markets. It would then be used by the Onsite GRC 80 to convert the outgoing webpage 70 to the globalized one 80 for a particular market (say Spanish/Spain, es-es) and the Spanish version of that page would be sent on 110 to the user 140. Specifically, the Onsite GRC would separate the html from the ‘strings’ and replace them with the translated ones if data for those strings existed in the RAM store. It would also look to see if any information about images or segments were in the RAM store that might match those that exist on the web page being transformed 70 and if so, manipulate that segment according to the instructions for it held in RAM. What follows is a more detailed description of this process.

i. Retrieving the Data in an Onsite GRC model.
Web Service Calls and in-RAM caching
In traditional globalisation, databases were not the typical store of globalization information. This was most likely due to the fact that retrieving information from a database is slow, as it typically resides on a separate machine from the web server and also stores a lot of data on disk. However this can be avoided by an OnSite GRC subscribing to an infrequent event, preferably the Restart event of the webserver, and then loading all of the data in one shot at that point 40,50 and holding it in RAM. The data is preferably ‘in the cloud’, i.e. resides in a remote database outside of the network, preferably controlled by a separate Globalization Company (GC). To access that data, the GRC 80 could make a request under any number of web protocols to an API, served by the GC's webserver/s 15 that would query the database 10 and return the data to the GRC. The preferred embodiment of this request would be as a ‘web service call’, in which the client's web server 60 would call the GC's web server 15 and receive a response from it. If a less preferred embodiment, the GRC 80 could query the database 10 directly, and bypass the GC's web server.
Timing of the Web Service Calls
These calls to an API/Webservice could be made at any time, but the recommended method would be to call them at an infrequent event, such as the Web Server's restart event. In the .NET world for example, this time is known as ‘IisReset’ and can in that environment for example be referenced by placing code in the Application_Start event of the global.asax file. That event is fired when the web server (HS in the case of a .NET environment) is restarted, which typically happens during a deployment of new code to the web servers. Of course the calls could be segmented into a series of calls or timing otherwise manipulated to suit a particular need, but generally the preferable method is upfront loading on server restart.
The data is retrieved once when the web servers are started and then holds all the globalization data in RAM for fast access as needed during the strings and segment replacement cycle of the GRC. Preferably, each web server in the web farm holds a redundant in-RAM copy of the globalization data But there could also be one or a series of dedicated globalization data servers, to which the other servers in the farm make queries.

ii. Server-side GNC Bypasses Performance Issues of Proxy-Based Globalization
A Server-side GNC has no problem in handling the dynamic page requests that the LPSes could not. The request comes in for the shopping cart, for example, and the Server-side GNC intercepts the outgoing UI code or html, makes its replacements, and sends the output on its way to the user. The only performance delay is in extracting and replacing the strings and in altering the UI code segments. Because this is done entirely in RAM however, on the original server in which the call was being processed to begin with, without any server-to-server call to another computer, this process is very fast and typically takes from 15-150 milliseconds (ms). This is in contrast to the 1-3 full seconds that would be required for an LPS system to return such a dynamic (uncacheable) page.

iii. Server side GRC in Conjunction with Existing Edge Caching Network
Also, this technique can still exist in conjunction with the general proxy server concept of “edge caching”, common in the industry, where distant “edge servers” close to the users, on the other side of the world from the origin servers, intercept the pages and return cached copies for the sake of turbo-charged performance. A company can do this by subscribing to an edge caching service and simply specifying certain URLs that do not have a very dynamic need to be allowed to be edge-cached, while the others such as the shopping cart are not and simply pass through to the origin servers. If the company had used an edge caching network before employing this Agile Enterprise Globalization technique, they would already have to be doing this, and no changes to those settings would be required by the introduction of the Onsite GRC.

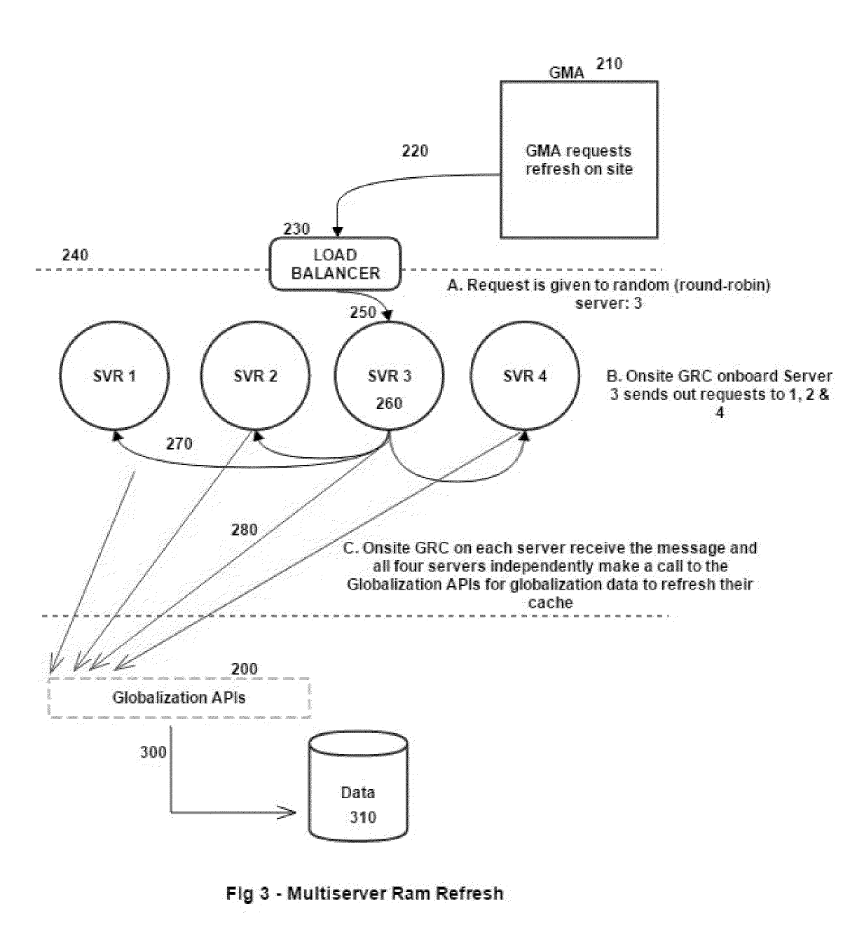

iv. Publishing the data with the Onsite GRC
Using the traditional globalization technique, a translator has to wait a long time to see the results of his translations on the website for which they were designed. The resource files from all over the world have to be emailed and assembled, incorporated into a new build and then deployed. This greatly encumbers the translators and other globalization professionals because they are “working blind”, sometimes not knowing for days what the effect of their changes will look like on the website or other target application for which it was intended. A “build” and “deployment” have typically been needed to see the results of the webpage after the translations. This means the website project needed to be compiled and then all of the files involved in that website pushed to all the webservers.
Using the Agile Enterprise Globalization technique, they can preview their changes immediately with the click of a button, even from a centralized application in the cloud.
They can do this because the Onsite GRC 80 is active on the live web servers and can at any point, given the right instructions, show any given page in its native state or its globalized state, for a given market. Therefore when a translator is working on a page, he can query the page in one embodiment, with a particular request in the URL, a technique common in the art, and the page can, after clearing his login credentials, serve up the translated page to him. Even if the page is only half-done, and not available for the public, the Onsite GRC can still render what is done and return that to the translator if he passes the correct instructions (typically via the URL) to the web server rendering the page, and has his credentials cleared.
However, how does the new data the translator has entered (the translations) get to the GRC for it to use in showing the translator a preview of his work? This is done by sending a directive in the URL, typically by the GMA for the GRC to refresh its RAM cache. The GRC then does the same thing it did at the web server restart event, which was to query 40 the GSC's web server 15 at which point either the full dataset for the website or only a needed subset of it is returned 50 to GRC.
In LPS-based translation systems, already existing in the industry, the translator can see his work immediately using a Proxy Preview technique. The original page is retrieved from the origin server 60 and reconstructed on the GSC's web server 15 and shown to the user. However, only an approximation of the page is being shown using this technique. The page has to be manipulated in various ways, ie ‘relative paths’ inside the page pointing to various supporting files such as .css, js, must be altered to be made absolute, ie contain the full path to the resource, or to be copied over to, and served locally from the GSC web server 15. The javascript may encounter ‘cross-domain’ failures—calls that are not allowed to be made from one domain to another. The actual server serving up the page is different. So for many reasons using this technique, the page may not appear as it actually will when it is pushed live. Only with this proposed invention, in which the translator is seeing the page using precisely the same technique, preferably on the same machine, as will be used when the page is rendered live, can the translator see a faithful globalized version of the page, where it will appear exactly as it will when it is pushed live.
Multiple Server Web Farms
To push the translator's edits to the GRC where the client has one web server 60 is more straight-forward. To do this in an environment in which there is a web farm containing multiple servers, a mechanism proposed here and referred to here as Multiserver Ram Refresh (MRR) must be employed.
Multiserver Ram Refresh
From FIG. 3, when a translator clicks a button in the GMA 210 indicating that he wants to refresh the data on the server that the OGRC is using, that app can send an encrypted secure call 220 to the target website telling it that it wants the OGRC to update its cache. That request will land on one of the several servers on the web farm, typically an undetermined one 260. It then can know what the other internal IPs of the other servers are, either by configuration, or by data originally input into the GMA 210. At that point, it will then make a similar call to the other servers in the farm 270, directing them to only make their own call 280 to the globalization APIs 290 and not send out further requests. The data will then be returned to the GRC on each box and each box will independently have a separate full copy in RAM of the globalization data. The mechanism can be written in such a way as that it will refuse requests that are too close together, according to some configurable time.
It is preferable that the call to the other servers 270 be made ‘async’, which means that the program not wait for one request to another server to complete before it begins the next request, and before the first receiver server 260 updates its own cache. In this way, the servers update simultaneously and the process performance would be ideal.
   Once the data cache of the GRCs have been refreshed, the translator will be able to see the changes immediately.

v. Programmatic Access, Internal Resources and Templates
a. Programmatic Access
The Agile Enterprise Globalization technique proposed in this paper can handle the dynamic web pages that the LPS systems cannot. It can replace any strings without caching the entire page, show or hide individual sections, alter any html of those sections and show different images for different target markets, all without any coding. However, it sometimes might happen that the particular demands of a software application are too complex and programmatically involved to accomplish entirely with the ‘post processing’ globalization technique employed by this invention. To handle these ‘edge cases’, the present invention might have to, for those pages where it was necessary, return to the traditional approach, which is more manually intensive, but provides the direct granular control of the underlying elements needed to accomplish the task.
Using the Agile Enterprise Globalization technique, in the embodiment where the Onsite GRC is an executable referenced by the particular project, it is possible to greatly minimize the work that is needed in this case, and to allow a direct programming technique that folds in very smoothly with the existing in-the-cloud agile architecture.
The Onsite GRC is a program that can be referenced in the project of a web or other application, but because it is referenced by the client application it also can provide properties and methods to the ‘client’ developers working on the web or other project. Because this is the case, a programmer needing to perform a complex globalization task, can get the translation for any string in one line of code, without ever having to extract that string, create a resource file or write a custom call to an API. They can for example code this:
divOutput.innerHTML=GlobalizationCompany.Intemational.GetString(stringToTranslate);
All strings extracted, entered and published by the GMA were loaded automatically at reset time by the Onsite GRC and loaded into RAM. The Onsite GRC also knows what market it is in. Now the Onsite GRC can hand out translations for any given string to any client developer that is asking very easily. Also, this provides direct access to the data managed by the GMA, and does not require that for these edge cases, the situation be handled completely out of band. This is in contrast to the traditional technique where the strings have to be manually extracted and placed in resource files locally, and then code be written to retrieve them. It is also in contrast to a pure Translation Proxy Server approach where the strings would have to be manually imported in the form of resource files into the application from the database store, or custom code would have to be written by the developer to call a remote API from which to retrieve the strings entered/translated by the GMA.
b. Internal Resources and Templates
Programmatic Method
An internal resource like an email, that is not exposed to the world as a web page is, poses a problem for post-processing globalization because the GMA cannot see it to automatically extract the strings from it. Also, the web application Onsite GRC cannot automatically see it in order to transform it.
To get around this, first an email template must be uploaded, or otherwise sent (emailed to) the GMA system. At that point, it can extract the strings from it like any other web page. Now to actually perform the globalization transformation at run time, the developer can explicitly make a call via one of the methods provided for programmatic access on the Onsite GRC, like:
string translatedEmailContents=GlobalizationCompany.Intemational.TranslateResource(emailInEnglish);
This method essentially calls the same routine the Onsite GRC does when translating a web page or other public resource, but offers it explicitly as a method to the client software developers. In this way, they can translate an entire email in only one line of code and not have to go outside of the GMA system to manage the strings. In the traditional approach, or even the translation proxy server approach, the developers must pick apart the strings of the email as in any other page or resource.
Web-Server Post-Processing
Another way to handle emails would be to use an embodiment of the Onsite GRC that is not attached to the application, but in the case of a web application, to the web server, as in an Isapi DLL. These web servers serve emails as well as web pages, so at this level, the isapi DLL would be able to do the globalization transformation to them just as any web page, but hooking into a later life cycle event such as ‘pre-render’, transforming the body of text, then sending it on its way.

vi. Alternative Platforms
In this section the present invention have focused on a Web Server embodiment of an Onsite GRC. However the same concept can be employed in a Mobile Application, Client-side web application, Native Client application, or on another device.
Mobile Application
Increasingly, mobile applications are being written as web applications. That is to say that the browser of a mobile phone queries a web page, rendered by a Web Server, just like a normal browser does a normal web page. The only difference is that the styles and design are accommodated to fit the mobile device rather than a computer screen, and that there are some unique features, such as GPS coordinates of the device, that the web application can take advantage of. For these types of mobile applications, the previously discussed Web Server embodiment of the OnSite GRC invention is all that is needed. This is because these applications, just like web sites, are served on Web Servers, and employ html as their markup language, which is to say that the phone screen's html is assembled by those Web Servers and once assembled, sent on its way to the phone, just as it the case with web pages.
There are also, however, native applications written for mobile phones that run directly on the phone itself, and whose screens are rendered and put together by code that resides on that phone. For these applications, a similar approach would be taken for the OnSite GRC:
a. An executable would be installed on the phone as a plug in that would be referenced by the Mobile Phone app.
b. That executable, which is the OnSite GRC for the mobile phone platform, would make a web service call, preferably at the time the application is first launched on that phone to retrieve, and store locally, the globalization information.
c. At an event which is after the application's rendering of the screen, but before that screen has been sent to the user, the Mobile Onsite GRC does exactly the same thing that the Web Server Onsite GRC does: it extracts the strings from the output UI code (not html, but a different UI language), replaces them with translated versions accordingly, and also performs Segment Control as described in this paper. Although not html, the UI language that describes the screen is still determinative and predictable enough to write algorithms that can extract the strings according to the techniques described in the String Extraction section of this paper. The result is a screen that has been globalized for the target market.

### Clientside GRC

In another embodiment, the GRC can still be directed at transforming web pages, but instead of being placed on the web-server, can be placed client-side, on the end user's computer in which the browser resides. In the preferred embodiment, this would exist as client-side code, preferably javascript, that is invoked by reference to a .js file on the web page that is to be globalized. In this embodiment:
a. The Onsite GNC can be referenced by the web application in the form of a reference to an external clientside script file (ECSF), preferably a javascript file with a ‘.js’ extension. In client script there is the equivalent of a ‘pre-render’ event that the OGRC can hook into, and it can, just as it does in the case of the web-server-based Onsite GRC, extract the strings, segments and images it needs from the html, and perform whatever replacements are necessary to produce the globalized page, just as it does in the web-server embodiment. The difference here is that the globalization transformation of the page will happen at the client, ie at the user's browser.
b. At the time it is first run, with a variable delay, code (preferably javascript) in this .js file performs a query, to retrieve the globalization data. In this embodiment it is recommended that only the data for the market in which the application is currently being viewed be retrieved. The resulting data is stored in RAM in javascript by that application, held physically by the user's browser. Certain techniques are known in the art to keep this RAM alive as the user leaves one page and goes to another. One is to employ/inject a ‘persistence frame’, a small invisible frame on the webpage that is never refreshed as its child frames change from page to page and to hold the data by the code in that invisible frame. A more common and preferable method is to use a technique offered by modern browsers known as “local storage” where the data is held by the browser across loads of different pages on the same domain. As in any Onsite GNC, the timing can be varied and the data can be loaded in “chunks” rather than all at once.
c. The globalization data can be sent to the Client-side Onsite GRC in any number of formats/mediums. In one embodiment, it is sent via the creation of a custom .js file, which is created by software on the GSC servers 15 and then referenced by the ECSF. In this way, that entire file can be cached locally, at the user's web browser, and exists across user sessions (ie after they closed their browser) and need not be queried again, until it is changed. This would minimize delays caused by this globalization system with the page's load time. In another embodiment it could be returned by an ‘ajax call’ (a call from the web page to a web server that does not incur a postback of the page) as JSON, a commonly used format for data held in javascript.
d. In order to implement this, a client needs to install a reference to the ECSF on the page which he wants to be globalized, rather than install the GRC on the web-server.

### Native Applications

Native applications are applications such as WinZip, which are not associated with web pages, and run on the user's machines. The screen assembly happens on the user's machine. In another embodiment, the GRC exists as an executable that resides on the end users's computer, as a component of such a native application. In these environments the present invention can follow a similar pattern:
a. The GNC is “referenced” by the application, which is a common practice in software development.
b. At the time of the initial run of the program, or other time, or in chunks, the GNC will make a web service call to retrieve the globalization data for the market in which the host application is running. The data is stored locally in files for faster retrieval in subsequent startups. The data is loaded into RAM, in similar object structures to those used in other environments.
c. The application either ‘hooks in’ to a “pre-render” event, alters the data that embodies the screen before it is displayed, and sends it along its way for rendering, or if this hook or event is not available in a particular platform, responds to an event explicitly fired by the host app developer, or to a method call explicitly invoked by that person.
Native applications, like Web Servers, have “engine's” (like Avalon or GDI) that render a screen, and although the screen is not represented in html, it is represented with another (more primitive) data stream, viewable as a series of characters. Although more challenging, there are predictable, determinative patterns in this data from which algorithms can be written to determine the starting and ending point of strings and segments and the transformations can be made.
Alternatively, there are fundamental APIs available in the operating systems, such as GetWindowText in the Windows operating system, that can allow such an application to retrieve the text of, and write text to, any ‘window’, ie subcomponent of a screen in a native application.

### II. Advanced String Extraction and Segment Control

### String Extraction

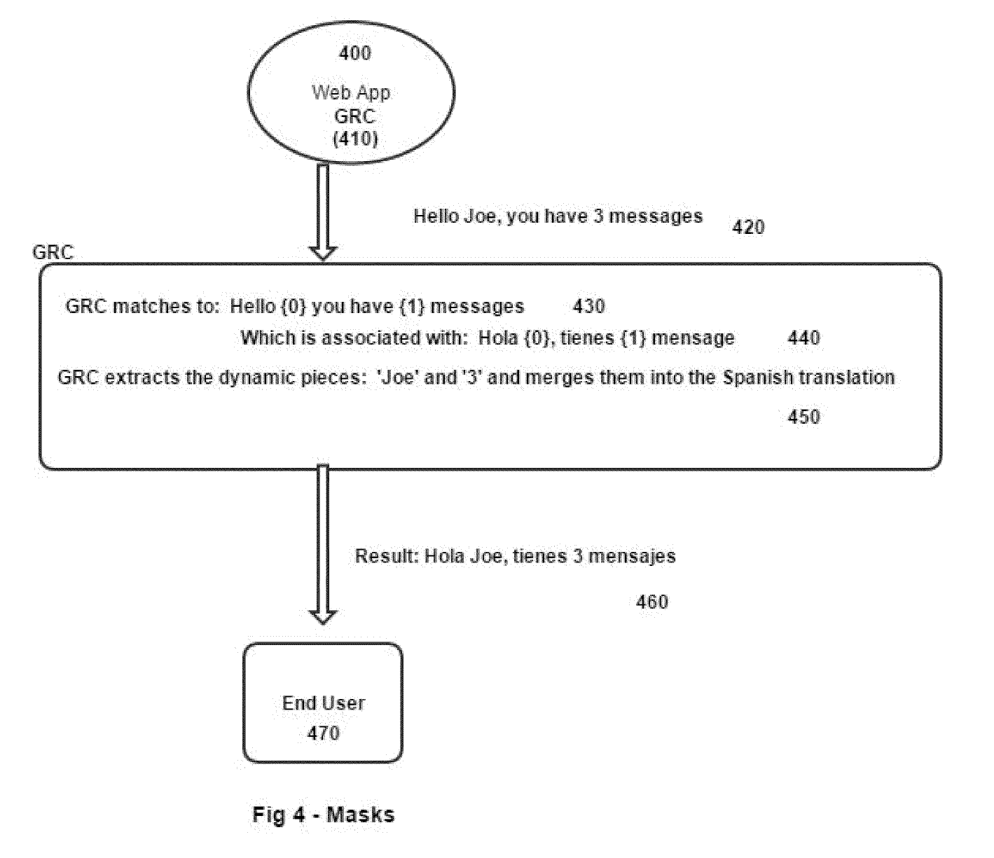

a. String Extraction Generally
   Generally speaking, automated string extraction is a technique that has already existed for years, by which strings are separated from the surrounding UI code.
   For example, in the html behind a given webpage, there may be this snippet:
   <div style=“font-size:10px”>
   See more products like this
   </div>
   In this example, by looking at any snippet of text in between the “>” and a “<” character, the string can be extracted from the UI code. As the language and nuances of the structure language become more complex (JavaScript, JSON, mobile app ui representation), it becomes more complex to extract the content from the structure, but it is nonetheless always predictable and achievable, and exists commonly in the industry today.
b. Specific Enhancements to String Extraction
   The following techniques are enhancements to traditional string extraction, which are employed by the proposed Agile Enterprise Globalization invention:
   i. Masks
      Sometimes one piece of a string will be dynamic, as in “Hello Joe, the user has 4 new messages. ” “Joe” and “4” are the dynamic pieces of this string, always changing as the rest of the string remains the same. Using runtime string storage and runtime string replacement, this presents a problem. Using the traditional approach, the problem is tackled manually as in this example:
         String greetingString =GlobalizationHelper.GetTranslatedString(“MainPage.Greeting”); greetingString=greetingString.replace(“{0}”,usemame); greetingString=greetingString.replace(“{1 } ”,messageNumber); divGreeting.Text =greetingString;
         The ‘post-processing’ approach for string replacement employed by this invention, where the string replacements are made not by manually written code for each sting, but instead in a generic way, after the page is rendered, runs into a problem here. Without custom manual code, how can it deal with this situation? It can do this using a technique proposed here—a ‘Mask’. From FIG. 4, after the GRC (410) has extracted the runtime message: “Hello Joe, the user has 4 new messages” (420) from the UI, the Globalization Professional (GP) can recognize this is a mask, mark it as such and select the words in it that are dynamic. The system will then store the string as:
Hello {0}, the user has {1} new message (430)
   marking it in storage as a Mask.
   In Spanish, this will be translated to:
Hola {0}, tienes {1} mensajes nuevos (440)
   This string will be stored, with reference to the English original as its key.
   Then at the runtime replacement stage, the replacement program will use string extraction techniques and find this string in the webpage:
   Hello Bob, the user have 2 new messages
   When comparing it to the available strings saved to the database and held in RAM in the GRC, it does not find the string among them. This is in contrast to the other strings, in which it relies on an exact match. In RAM, it does find one Mask that looks like this:
Hello {0}, the user has {1 } new messages
   To see if there is a match, the GRC compares the non-dynamic portion of the mask with the extracted string, where the correct segments have been omitted. For example, the user can compare the “Hello” portion, the “, the user has” portion and then the “new messages” portion. If they all exist in successive position in the target string, then the user has made a match with the mask. Once the GRC has a match, then the GRC can also identify the dynamic pieces of the string by doing the converse. Now the GRC grabs the Spanish translation, and replaces the tokens ({0} and {1} in this case) with the dynamic pieces, in order, and the user get:
      Hola Bob, tienes 2 mensajes nuevos. 460
      In this way, using ‘Masks’, dynamic sentence constructions can be maintained in a runtime string replacement environment in which there is no custom coding.
      Also, the GP can be taken out of the equation by allowing an option whereby all numbers embedded in text sentences can be assumed to be masks, and whereby the GRC can otherwise learn, by watching which pieces of a string change dynamically, which piece of the sentence is the dynamic portion. For example, if the GNC sees that the string “Hello Joe” always changes, but “Hello” remains the same but “Joe” changes, the GRC can assume a mask structure of “Hello {0}” and present that to the GP by default.
ii. UI code Within Strings
   Typically the strings exist inside of the UI code, i.e. html. But sometimes it is the reverse. For example:
   This product is a great deal
   may look like this in html
   <div>
   This product is a <span class=“custom-italic”>great<ispan>deal
   </div>
   In this case, we want to consider the entire string one string, and not break it up into three strings. This is the better way to present it to the translator, for simplicity, and the retention of context and meaning of the sentence.
   To do this, an algorithm can be written that:
   1. Finds suspect ‘embedded’ ui tags, such as span and href.
   2. Counts the number of characters going backwards and forwards from it. If immediately before the tag is a substantial amount of ‘content characters’, where ‘substantial’ is configurable, but can start preferably with 5, (i.e. numbers and/or letters), before any other UI tag has been found (i.e. text, not html), or after the tag this is the case as well, or both then the present invention determine that this tag is ‘embedded’ and should be considered a part and parcel of the surrounding strings.
   To then extract the string as a whole, any number of techniques can be employed, preferably by ‘tokenizing’ the embedded tag.
   The algorithm can first tokenize the “span” references, and alters them, converting their “<” and “>” characters into something else before the primary string extraction algorithm is written, and then replaces them back after the string extraction is complete, or the algorithm can be altered to ignore certain types of UI container code, such as span statements. Using either primary algorithm alteration, or tokenization of increasing complexity, an increasingly intelligent identification of single strings as such can be accomplished.
c. Specific Enhancements to UI Control Outside of String Extraction
In addition to replacing strings for the purpose of translation, larger portions of the Overall code that creates or defines a screen, such as html does a web page, can be extracted and manipulated as well for the purposes of Globalization. This invention is a critical enhancement to software globalization that greatly expands its current reach and does not exist in the industry today. Inventions in the area of automated globalization have focused on translation (localization) and have left the area of marketization largely untouched, leaving that to developers to do manually, or ignoring it. Marketization is basically everything else, other than translation/localization that has to be done to transform a screen to its appropriate form for consumption in another market. Links have to be changed. Entire sections have to appear/disappear. Images need to be swapped sometimes because they contain text, sometimes because they show an English woman when they should show a Korean woman for example. Font bolding should be eliminated in some markets. Dates and numbers need to be converted. Currencies should sometimes be converted. Colors should sometimes be changed. Etc. This invention allows for a mechanism by which all of this can happen without manual coding.
i. Segment Control
   It may be desirable that one section, or snippet, of a page be:
   a. Replaced with something else (ie different html) entirely for a given market
   b. Ignored all together when performing globalization
   c. Shown or hidden according to market
   d. Manipulated to ‘stretch’ to accommodate longer translated strings
   e. Not made available to the translators so that it remain as is
   e. Otherwise manipulated
   Traditionally, segment control has been achieved by identifying a containing element for that section (i.e. a ‘div’ element in html) and then with code written custom just for that section, manipulate it, as in this example:

if(market = InternationalMarketCodes.Egypt)
{
divProIsraelSection.Visible = false;
}

However it is possible to bypass completely the need to custom code this. To do this, in the GMA, the user can visually in a preview screen, or by using begin and end markers, specify a segment section. Then he can specify using the application which markets it can appear in, which it cannot, whether it should be immune from generic globalization alteration, or any other number of potential alterations.
The information identifying that segment and all of its entered attributes can then be held in the database.

### Identifying the Segment

In the traditional approach, the segment is identified by the “id” of the containing UI element:
<div id=“divProlsraelSection”>
A bunch of text and other UI markup
</div>
In code, the section can be referenced by its id.
divProdIsraelSection.Visible =false;
   However, one of the primary goals of Agile Enterprise Globalization is that it can be performed without any custom coding, i.e. without having to manually alter the underlying page. So what happens if the containing UI element does not have an id? How can the segment be identified? This is one the primary challenges of Segment Control. Here are ways in which it can be identified even though it does not have an Id.
   a. Full Contents
   The complete contents of the segment can be extracted, and the segment can be identified by its full contents, in conjunction with the markup of the containing UI element. For this to work, subsequent iterations to that section must be made within the GMA, and the underlying UI markup left alone. In this embodiment, the GP visually identifies a segment by hovering over various segment candidates on the page and clicking when an outline shows the correct segment is identified, and then selects a choice such as ‘define as segment’. The entire segment's html contents are then written to the GSC's database, in a special table dedicated to segments. This data is then loaded by the GRC, typically at web server reset, along with the other strings and other globalization data.
   When the GRC now renders the page, it looks for any matches with the segment html it has held in RAM, with anything that might be on the page. If it finds a match, it then performs the manipulation specified for that segment, which was held in the database, and also loaded into RAM.
   b. Fuzzy Match
   Because the contents of these segments sometimes change, and even more problematically because the most popular browsers often alter the underlying html where there are ‘errors’, and therefore the true native html is often inaccessible to the javascript that would try to identify and store a segment's full, html, there is a need here to identify the segment based on a ‘fuzzy match’. An Algorithm can be written to establish a ‘near match’ between the last stored contents and current contents of a section with a number of techniques including, but not limited to:

### 1. Word Cluster

This algorithm would search for the all of the words (characters before the next space) in the segment, individually, on a page. If there is a fuzzy match, the present invention would expect to find a dense cluster of word matches in the area of the segment. A threshold of density could be used to establish the match area and then more precise competitors to the contents of record could be used to establish the precise beginning and end of the segment.

### 2. Converging Bookends

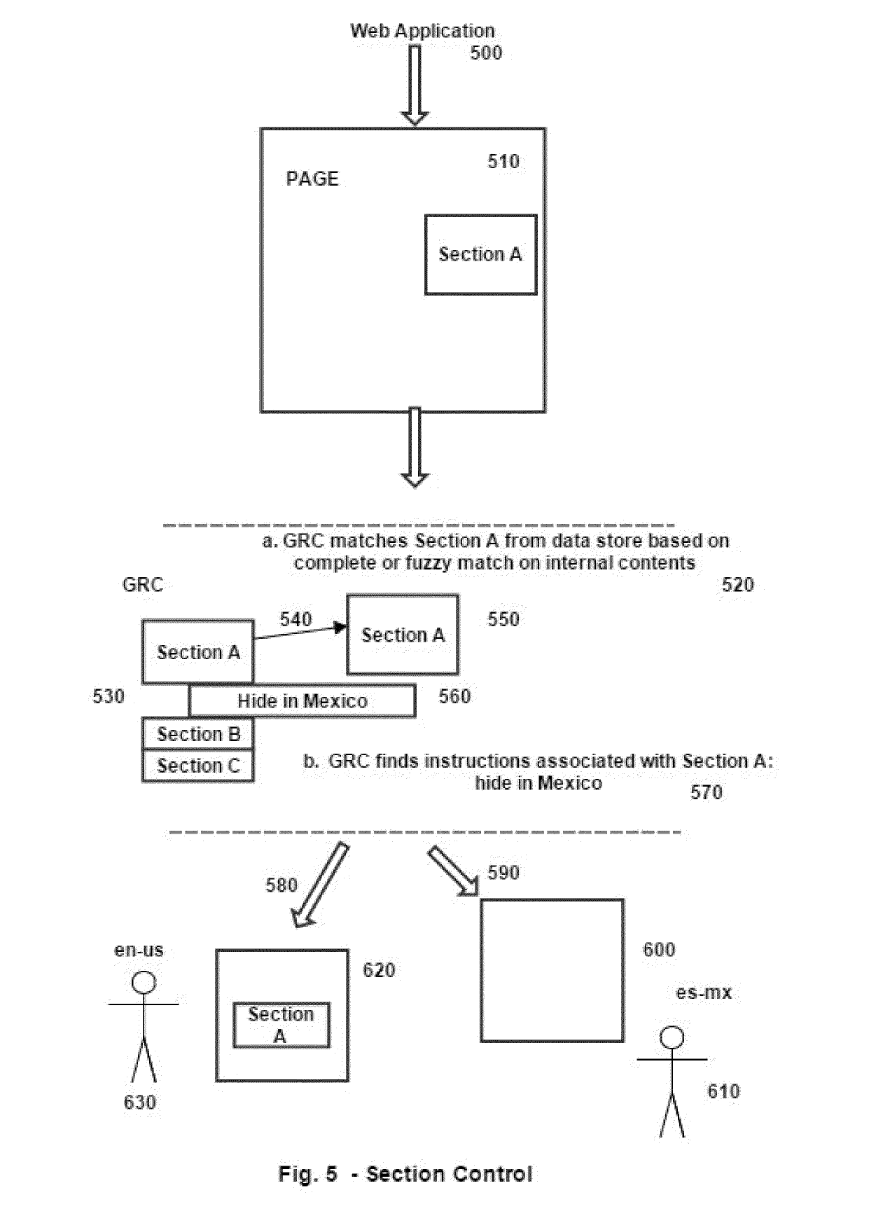

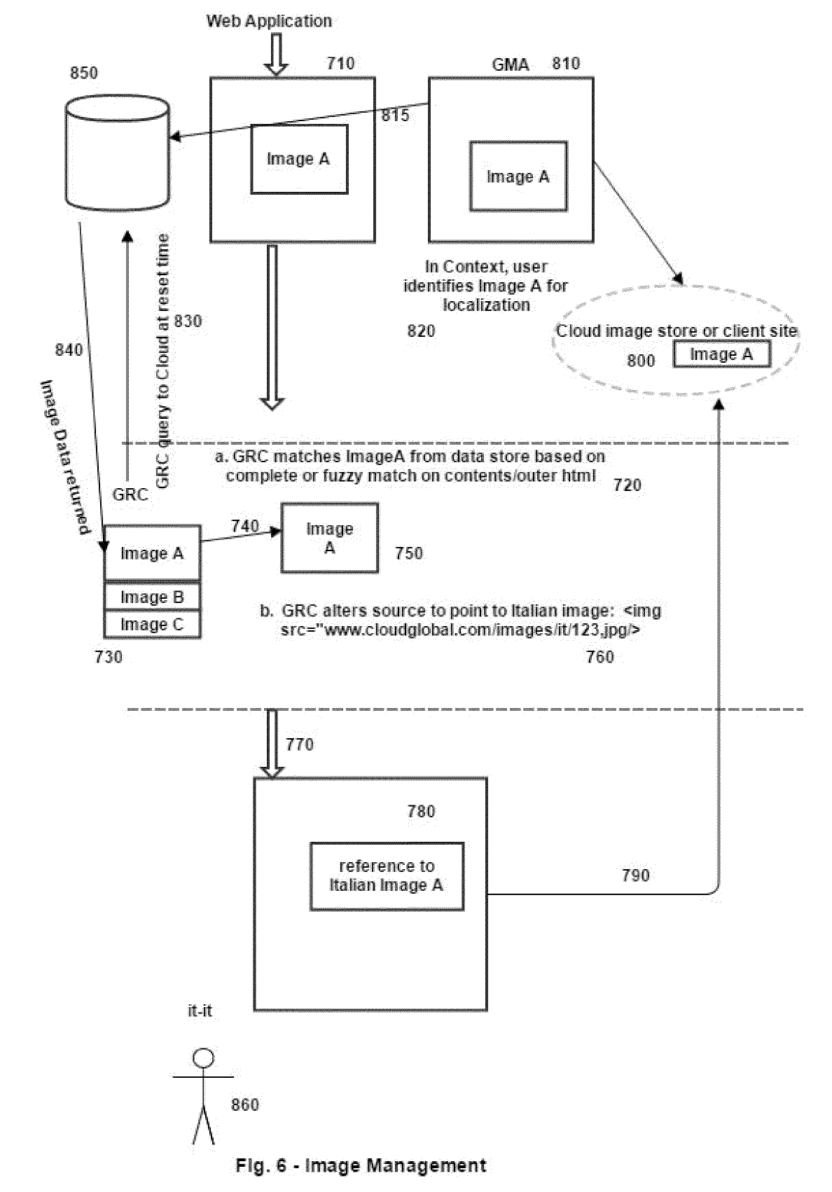

An algorithm would first search for any markup on the page in between the beginning tag and ending tag of the segment as it is stored in the database. If there is only one match, it stops there. If there are multiple matches, it then moves on to the next set of html tags, ie the second and second-to-last tags. If there is only one match, it stops there. If there are zero matches, then does a character-by-character match on the tags of the segment as stored in the DB, versus those of the candidate segments. If one of the candidates have a match over x % on characters, and is y % greater a match, where x and y are configurable values, then any other candidates, then it stops. If there are multiple matches, it goes onto the next level of html exterior tags. It repeats this process until it finds a match, or finds nothing.
Once the GRC can identify the segment, then it can manipulate it in the globalization transformation as per the instructions for it saved to the database.
From FIG. 5, a web page 510 is presented to the GRC with ‘Section A’ in it 520. The GRC looks through the various segments on record in its RAM collection 530 and identifies one of the segments 520, Section A 550, based on a fuzzy or complete match. It then finds in the instructions associated with this segment in RAM, a directive to ‘hide in mexico’ 560. This can be stored in the database for example as ActionType and Market (es-mx). The GRC, which knows which market it is in because it is able to read this information in the request that came from the browser, a technique commonly known in the art, then removes the entire section during its globalized rendering of the page. To users with an es-mx setting in their browser, a web page without Section A 600 is returned 590 to the user in Mexico 610. A version of the page with Section A in tact 620 is returned to a user in the US 630.
a. Auto-stretching—a particular example of Segment Control.
   When an application such as a website is translated from English to another language, the strings often get longer and many of the pages ‘break’. That is to say that, the container in which they reside were not written to ‘stretch’ to accommodate longer text and the text spills outside of the container. A typical example of this would be a button with a defined width, just long enough to say ‘Next’ in English, but does not contain the German translation or “Nächste”.
   In traditional globalization, there is typically a process called ‘pseudo localization’ in which long nonsense translations about 150-200% the length of the originals are auto-generated, included in the compilation and given to the developers to show them all the places in which the application is now broken, and all the areas they need to fix. The developers then go about the cumbersome and time-consuming process of manually fixing all of those areas so that they stretch or otherwise accommodate the strings. This is one of the most painful and time-consuming pieces of the globalization process.
   It is possible for the Agile Enterprise Globalization system to handle many of these situations and avoid the need for any manual coding. In the GMA, the user can identify the segment, such as a button, visually, and indicate that he wants it to ‘auto-stretch’. The GRC can then identify it, and inject UI code and styles that can do that. In html for example, one way would be to set a style=“width=100%” attribute would override any css class represented elsewhere and cause the button to stretch. In more complex examples, the button might have as its background image a repeating image of a certain width. More complex css techniques known in the art to cause this image to repeat horizontally can be injected into the page.
   The button would be identified in the first place as any other segment would, given the technique outlined above. But then it would have an instruction associated with it, would be to auto-stretch. At this point, instead of hiding the entire segment, as was the case in the Mexican example above, the GRC would inject the necessary style, css and other code if necessary to make it stretch.
   On the other hand, it might be that a segment such as a button cannot stretch because it is otherwise constrained by other elements. In that instance the GMA user can specify that rather than stretching, the font size should get smaller. The GRC could in that situation, inject css and stylization code known in the art to reduce the font size.
   In addition to this technique, an In-context GMA (discussed later) can be used to allow users to make edits directly on the page, and see immediately if they need to use a smaller variant of the word to make it fit, a technique which may sometimes be desirable to avoid the developer-intensive ‘psuedo localization’ phase.
   Finally, the In-Context GMA could allow a GP to manually stretch the button by a form of segment control where they specify different html all together for a given segment, and the GP manually enters a new width for the button, for a given market. In another embodiment, the In-context GMA would allow the user to select the button and manually stretch it, using javascript techniques known in the art to accomplish that, at which point the alternate html that is required to product that effect would be stored in the database as the alternate html for that segment for a given market.
b. Currency Conversion and Display
   Currencies can be, if indicated by the user in the GMA, converted. To do this, a daily backend process can collect the exchange rates each night and store them in the Cloud Database. Then if GRC detects a reference to a currency amount (i.e. $5.34), then it can look up the conversion information from that data, and display the new amount in the target market's currency, along with the correct display for that currency.
   Custom control of that display could be controlled by a table, the information for which was entered from the GMA, into a structure such as this, to give one example:
c. Image Management
   Images often have text embedded in them, which means that a new translated image must be displayed for each market as appropriate. So far no automated process exists to change these images, nor is any such process being claimed here. However, in traditional globalization, this communication with the designer that is going to create these translated images is done out of band from any globalization program, i.e. typically over email. To improve upon this, like with the other segments, an image can be selected visually in a In-context GMA, and the user can indicate that this Image needs to be under ‘image control’. Then the GMA can be extended to allow one user to enter the English (or source) text into the system, and let the translators translate it as they would any other string, and then, allow the designer to log on directly, and read the translations in each language for each image under image control.
   In addition to this, no process exists today whereby certain images can be shown in certain markets only, without manual coding required. With Agile Enterprise Globalization, it is possible for a GP to click on part of an image in the In-Context GMA that under image control, or drag another image from the desktop over it and drop it, while seeing the page in a certain market, to thereby update the image in that market. When this happens, the uploaded image would then be copied to a server, and/or edge caching network either of the GSC or the client's.
   Then, at this point, when the GRC detects an image section marked for globalization in a rendered screen, it can alter the source attribute of the image tab to point to the appropriate location for the localized image for that market and the appropriate image for the appropriate market appears.
   From FIG. 6, in the In-Context GMA 810, the GP visually marks an image for ‘globalization control’ 820. The path to this image, along with this instruction, is written 815 to the database 850. The designer or other GP, after having manually created the alternate image in Photoshop or other image manipulation software, goes into the In-Context GMA, views the page in a particular market, and drags the intended image over the one displayed on the page. Javascript that is part of (referenced by or injected into) the In-Context GMA page uploads the image to the cloud 800, and writes the name, location in the cloud and market to the DB as well. On the run-time front, the GRC queries 830 the database 850 at reset time and receives back 840 data relating to this image 730. When the GRC is alerted of an incoming page 710 and finds that the page request was made from a user whose browser was set to the Italian market (it-it), it matches the image in the page against the image candidates in RAM 730 and finds a match using full or fuzzy matching described above. It also finds the instructions of the location in the cloud where this image for this Italian market now resides, and alters the src attribute in the <img tag in the page accordingly. 760. The altered page with the Italian version of the image 780 is returned to the Italian user 860.
      In this way, globalized images can be, for the first time, managed without any custom coding, or without any need to manually alter the underlying page.
      In the preferred embodiment, the In-Context GMA is an altered version of any web page that resides directly on the client's web servers. In an alternate embodiment, the webpage is served from a ‘preview’ site controlled by the GC, which performs a ‘server-to-server call’ to retrieve the source code of the original page by making a simple, publically available request to the client's origin server on which the page natively resides, and then, on the GC's preview web server rather than on the origin server, performs the transformation.
      In order to faithfully show the client's page on the preview GC-controlled web server, the page must be altered in a number of ways. In particular, ‘relative paths’ to various resources like javascript and css files, which work when the page is served from the origin servers, must be made to be ‘absolute’, ie include the pull path, including the domain, to the resource, which makes the preview technique less reliable. However, it is useful in that a potential customer of the GC could see how the process works without installing anything on their servers. The practice of a preview page generally is not new and is not being claimed as an invention here.

### Text Auto-identification

The proposed system suggests that a human being using the GMA identify the images that have text in them and then mark them as such, allowing the GRC to spot and swap the reference to them.
However, it is possible to auto-identify images with text in them. To do this, techniques already existing today using primarily neural nets to identify whether or not image contain text could be employed.
Furthermore, techniques existing today that can actually read the text inside an image, referred to as Optical Character Recognition (OCR) could be employed to extract the English or Source Language's text contained in the image.
d. Other Manipulations
   Along these same lines, any manipulation of UI code that served the globalization needs of that platform could be performed. It could also include, but would not be limited to:
ii. Blanket Globalization Alterations
   There can also be alterations to the original screen that are of a more general nature than altering strings or specific sections. This can be accomplished by looking for examples of the target elements requiring transformation and replacing them with the desired conversion. For example:
   a. Right-to-Left Conversion
   In Hebrew and Arabic for example, the writing goes from right to left. To make this conversion in html so that the page is “flipped”, a “dir=rtl” attribute has to be added to the body tag. However, this is just the beginning. There are many elements of the page, depending on the browser that is reading it, some tables for example, that will require the dir attribute as well, and other characters and code snippets that must be replaced and manipulated in order to make the whole page effectively go from right to left. Traditionally, this process is manual and cumbersome. Lengthy as these exceptions are, they are determinative and predictable and do not require human judgment. That is to say, they can be programmed into an algorithm. The Onsite GRC, to the degree that it contains this knowledge in the form of algorithms, can inject these alterations into a page automatically, without any manual developer work.
   b. Bold and italic control
   In Korea, their written culture is such that they generally do not bold or italicize text. Traditionally, it was a cumbersome manual process to alter the css and formatting directives in code for Korea so that this could be achieved. The Onsite GRC however, could be programmed to remove any bold or italic markup from a page, or in a .css (styles) file, or in any other file necessary to be scanned and altered.
   c. Encoding conversions.
   If a page must be translated into Greek, the page must have the proper ‘encoding’ so that it can support Greek letters. In a few lines of code in Html, the page can indicate to the browser the encoding that should be used to decipher the page. The UI conversion program can inject these lines as needed based on the language it knows it is translating to.

### III. In-Context Globalization Management Application (IGMA)

There exist today GMAs where the strings and globalization information for multiple clients exists in one database and are managed in one online application. And there also exist today limited in-context versions of that application where a sort of preview of certain text changes just made can be seen on a recreated preview of the page in question. However, what does not exist today is a truly in-context management application where the globalization changes can be made literally right on the page itself, something referred to here as ‘In-Context Globalization Management Application (IGMA). This is completely different paradigm for editing a webpage for globalization, and I believe constitutes a significant advance in globalization.
Such an approach makes it easy for globalization professionals to find the strings, as all the translator has to do is hover over a string on the web page and click it in order to edit it. It makes it much less likely that a string on a page is ‘missed’, either by the translator, or developer that was supposed to isolate the string, a major problem in current globalization systems where strings can only be accessed by lists of data and there is always a resulting disconnect between these lists and their ultimate appearance on the page. Because with this invention the editing is done directly on the page, and the effect is seen immediately, rather than the editing done on a separate list of strings, as is the case today. Most importantly though, it makes visual image and segment manipulation possible, as it provides a way for a GP to interact directly with a webpage and to thereby visually identify an image or segment and indicate how it should behave.
This technique opens the door to easily manipulating many other aspects of a page, as they are easy to find visually on the page. To show a new image for that market, a user would simply drag the new image from his desktop over the existing image. To conditionally hide a segment in a given market, he would select that segment, hovering over the page until the section he was after was highlighted, and then make a selection indicating that that section should not display in a particular set of markets.
Software globalization consists of two parts: localization, which is the translation, and marketization, which is the conditional display and formatting of sections, elements and images of a page depending on the target market. The current emerging practice of agile globalization in the industry thereby must completely omit the marketization half of globalization from its ‘agile’, that is to say coding-free, approach. Because these elements cannot be defined visually, they must in the end be manually referenced with various coding techniques such as that of asking the developers to hard code various attributes onto image tags in the source html of a page to indicate the acceptable markets for display for that image. The IGMA invention allows for the first time the other half of globalization—marketization, to be able to participate in the rapid development, build, deployment, and code-free globalization process.
All of this can be accomplished in any web page that is served from a webserver hosting the GRC, or where the GRC is hosted client-side, by coding the GRC such that it emits the necessary links, javascript, icons, css, etc into the html stream, in the correct spots though its ability to detect where strings start and end, and where images are, etc, and thought its ability to alter the page in any way. By doing this, the GRC can make the transformations necessary such that it makes the page ‘editable’ when it detects the page is in ‘admin mode’.
This can also be accomplished on a ‘preview page’, which is a page which tries to mimic the original page as bests as possible, a practice common in the industry, but served form another computer, preferably controlled by the GC.

A page is made editable by various elements of a computer program being injected into the page itself by the GRC during its rendering of the page. Client-side code, preferably javascript, styling instructions, preferably css, data about the translations and page design directives, preferably in the form of javascript object notation (JSON), and additional html markup, are all injected into the page by the GRC. In some instances the GRC does not have to inject all of these elements, but can merely inject a reference to them onto the page, such as a reference to a javascript file, which is already assembled and residing on a GC web server:
<script type=“text/javascript” src=“www.gccompany.com/some.js”></script>

These elements, when assembled in the right way, act as a program running inside the page, integrated into it, which transforms the page into one that is editable for the purposes of globalization.

To assemble these elements, in the preferred embodiment, at the startup time of the page, the injected javascript runs a routine that attaches an event to every potentially visible element on the page. This event is then subscribed to by a routine that sets the outline of that element to a certain color in order for it to appear selected when hovered over. Also, the element can, in the event, pass a reference to itself so that information about that element is available to the javascript program upon hovering or clicking. In this way, elements of the page become highlighted as the user hovers over them, and details of that element can be accessed after the user clicks, such as what its string contents are, or what the full html of a section is.
This information can then in turn be placed inside a text box which is then injected into the ‘Document Object Model (DOM)’ of the page, near the block of text to which the editing pertains, having the effect of the text box suddenly appearing around the clicked text. In addition to a text box, other html elements can be injected, along with css styling that supports them, such as an OK button. A javascript function can be specified to run upon clicking of the OK button. Since the javascript code has a handle to the most recently injected text box, it can retrieve the user-changed/translated text inside it, and then use a technique commonly known in the art as an ‘ajax’ call to send that data off to an application programming interface, or API, hosted by the GC, waiting to retrieve that call and send it on for storage in the database.
Conversely, upon load of the page, all the relevant data held by the GRC can be formatted into a format easily accessible by javascript, preferably JSON, and then injected into the page. The javascript program injected/referenced in the page now has easy access to all the translations and segment/image directives that it needs to display things appropriately. For example, the page can be made to have an ‘edit’ mode where segments marked for disappearance in a certain market, may not disappear, but instead have a big red X overlaid over them to display to the admin user the current state of that segment.
And in this manner, any user interface can be displayed to the user in response to the hover or click of any element, and action to alter its appearance or store user actions can be achieved. In this way, the page becomes ‘editable’.
In addition, ids for each UI element that does not have an id can be injected into the markup for that element by the GRC when in ‘admin mode’, for easier access to the element in question. The Ids would be generated, based on any algorithm that ensures that the ids be unique, such as simply counting up from 1. Here is an example UI markup resulting from this technique:
<div id=“234”>Hello</div><img src=“litdepenciljpg” onIclick=“EditUIElement(234)”/>
   The text box used to edit the text can be styled in any way, so that it looks like a text box, or looks like a more stylish box by making its borders invisible and replaced by more stylish borders of an encompassing div or span element, for example.
   Similarly, for Image Control, or Segment Control, the GP can hover over various elements to select a segment, which will become outlined when the proper point is hovered. At that point the GP can click and select a menu choice such as ‘define segment’, when viewing in the source language, ie English if that was the original language of the webpage. The data for the segment's contents are be sent to the database. When viewing in another market, such as Italian, that segment will appear with a special outline, indicating that this segment is under Segment Control and the GP can hover over it, click it and select the ‘Hide in Italian’ menu choice, or the ‘Alter HTML in Italian’ choice, etc. The changes made are saved via an ‘ajax’ call to the database.

### UI Examples

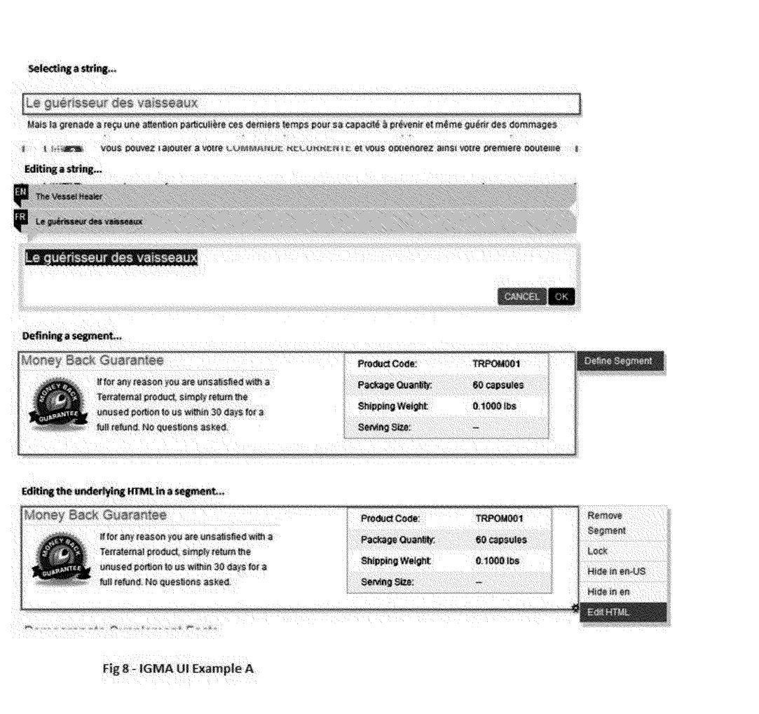

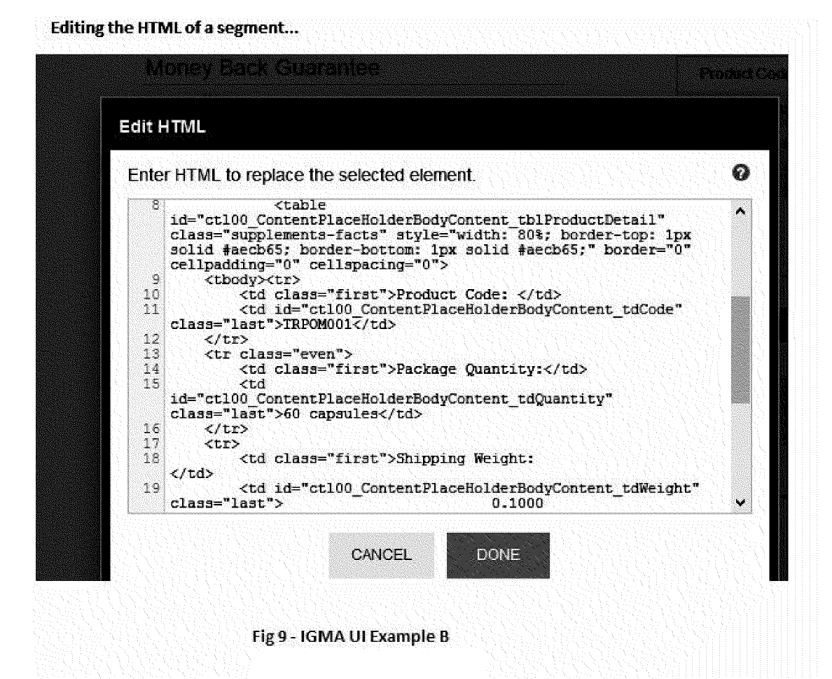

To better visualize the user interface of the IGMA, please refer to FIG. 8 and FIG. 9 for example snippets of ways in which the user interface could appear, integrated into the page itself, to accomplish such tasks as selecting a string, editing a string, selecting a segment, issuing a command against a segment and altering the underlying html of a segment.
From FIG. 12, an ‘admin user’ 900 requests 910 a page from the client's webserver 915, including a parameter in the URL that tells the GRC 1020 that the page is to be transformed into an ‘editable’ one. The GRC either redirects to a login page served by the GSC by issuing a standard http 304 redirect command, or by returning the html of the login page and disregarding the original page 920. Once the credentials are confirmed, the GRC now transforms 925 the page into an editable version of itself 930. This is done, in the preferred embodiment, by injecting certain javascript into the page, as well as references to other javascript and css files, hosted preferably by the GSC. This javascript and styling information is all that is needed to make this transformation. There are many embodiments which this can take, but the essential process is that javascript can be injected that alters the behavior of the page so that an element on the page can be selected in some way, and then some user interface (UI) can be injected into the page and presented by that javascript with which the user can interact to translate strings and to issue commands pertaining to images and segments. In the preferred embodiment, the javascript allows the segments to be outlined as the user hovers over them, and can then inject the markup, supported by css, to display a text box, menu choices, tabs, etc, to allow the user to alter a particular string, or identify a segment and issue commands pertaining to it, and to supply the javascript necessary to make calls/requests 960 to the APIs 970 hosted by the GSC's web servers 980 that save those changes 990 to the database 1010. This editable page 930 is now created by the GRC 1020 and returned 940 to the admin user 900. Again, the admin user interacts with this page to save changes relating to certain strings or segments, via the calls 960 to the APIs 970 hosted by the GSC servers 980) that then save the information 990 to the database. Once this information has been saved, the admin page can issue a ‘refresh cache’ directive to the client webserver 915, which will be picked up by the GRC 1020. The GRC will then issue a request to the API 1060 for refreshed globalization data. The APIs will in turn make a request to the database 990, retrieve it 1000, pass it on to the GRC 1070, at which point the GRC will preferably package it up into a more easily manageable structure such as a hierarchical structure of objects, and hold it RAM. If the client webserver 915 is part of a group of web servers (a web farm), then the invention described earlier in this paper titled MRR can be employed so that each server gets an identical copy of the data in RAM.
A standard user 1030 now visits the website and makes a request 1040 to the web server 915 to see the page. The original page 1050 is transformed by the GRC 1020 into the globalized version of the page 1080 using the latest data that was obtained in the In-Context editing process.

### No Need for String Scanning

In modem ‘agile’ translation systems in which translation of a page can be accomplished without custom, the web pages need to be ‘scanned’ at one point in order for the strings to be extracted and then written to the Cloud database en masse so that those strings can be presented to the admin user in the standard GMA. With the IGMA, however, strings can be written one at time, as they are translated, and the scanning step can be avoided all together.

### Content Management

Finally the IGMA, together with the OnSite GRC and other components of Agile Enterprise Globalization, also serve as a very effective and novel Content Management System, either for clients that want to use it in conjunction with globalization, or independent of it all together. This is because it creates a system by which any element of a page of any website can be edited in real time by those with the authorization to do so—without any coding, compilation deployment or release, and pushed live immediately.

Although the invention has been explained in relation to its preferred embodiment, it is to be understood that many other possible modifications and variations can be made without departing from the spirit and scope of the invention.

| Cited Patent | Filing date | Publication date | Applicant | Title |
|---|---|---|---|---|
| U.S. Pat. No. 4,599,612 | Dec. 6, 1982 | Jul. 8, 1986 | Hitachi, Ltd | Displaying and correcting method for |
| | | | | machine translation system |
| U.S. Pat. No. 5,724,593 | May 3, 1996 | Sep. 1, 1998 | Apple Computer, | Method and apparatus for managing text |
| | | | Inc. | objects for providing text to be |
| | | | | interpreted across computer operating |
| | | | | systems using different human languages |
| U.S. Pat. No. 6,119,078 | Oct. 13, 1997 | Sep. 12, 2000 | International | Systems, methods and computer |
| | | | Business Machines | program products for automatically |
| | | | Corporation | translating web pages |
| U.S. Pat. No. 6,345,243 | May 27, 1998 | Feb. 5, 2002 | Lionbridge | System, method, and product for |
| | | | Technologies, Inc. | dynamically propagating translations |
| | | | | in a translation-memory system |
| U.S. Pat. No. 6,161,082 | Nov. 18, 1997 | Dec. 12, 2000 | At&T Corp | Network based language translation |
| | | | | system |
| U.S. Pat. No. 7,584,216 | Feb. 23, 2004 | Sep. 1, 2009 | Motionpoint | Dynamic language translation of web |
| | | | Corporation | site content |
| U.S. Pat. No. 8,566,710 | Oct. 30, 2009 | Oct. 22, 2013 | Motionpoint | Analyzing web site for translation |
| | | | Corporation | |
| U.S. Pat. No. 7,627,479 | Feb. 23, 2004 | Dec. 1, 2009 | Motionpoint | Automation tool for web site content |
| | | | Corporation | language translation |
| U.S. Pat. No. 7,607,085 | May 11, 1999 | Oct. 20, 2009 | Microsoft | Client side localizations on the world |
| | | | Corporation | wide web |
| U.S. Pat. No. 7,389,221 | Jul. 17, 2000 | Jun. 17, 2008 | Globalenglish | System and method for interactive |
| | | | Corporation | translation |
| U.S. Pat. No. 7,207,005 | Dec. 5, 2002 | Apr. 17, 2007 | David Lakritz | Translation management system |
| U.S. Pat. No. 7,016,977 | Nov. 5, 1999 | Mar. 21, 2006 | International | Method and system for multilingual |
| | | | Business Machines | web server |
| | | | Corporation | |
| U.S. Pat. No. 6,964,014 | Feb. 15, 2001 | Nov. 8, 2005 | Networks | Method and system for localizing Web |
| | | | Associates | pages |
| | | | Technology, Inc. | |
| U.S. Pat. No. 6,604,101 | Jun. 28, 2000 | Aug. 5, 2003 | Qnaturally | Method and system for translingual |
| | | | Systems, Inc. | translation of query and search and |
| | | | | retrieval of multilingual information |
| | | | | on a computer network |
| U.S. Pat. No. 6,345,243 | May 27, 1998 | Feb. 5, 2002 | Lionbridge | System, method, and product for |
| | | | Technologies, Inc. | dynamically propagating translations |
| | | | | in a translation-memory system |
| US20030004703 | Jun. 28, 2001 | Jan. 2, 2003 | Arvind Prabhakar | Method and system for localizing a |
| | | | | markup language document |
| US20130197898 | US20130197898 | Aug. 1, 2013 | Electronics And | Method and |
| | | | Telecommunications | apparatus for |
| | | | Research Institute | translation |
| WO2006055686 | Nov. 17, 2005 | May 26, 2006 | Sue Ellen Reager | Global localization |
| | | | | and customization |
| | | | | system and process |
| US20030046058 | Aug. 26, 2003 | Mar. 6, 2003 | Jorg Stuckler | Translation text |
| | | | | management system |

1. A method of altering a software display screen by a computer program residing on a computer in which said screen is being rendered, referred to in the specification as the onsite global runtime converter or grc, using translations and marketization data input primarily by human beings, so that said screen can be presented appropriately to an end user in another country, the method comprising:
receiving the source markup for the said screen on said computer rendering a display screen by said grc computer program residing on said computer,
receiving the language and country preference of said end user requesting the display screen from the operating system, browser's setting, domain name or URL parameter for use by said computer program,
transmitting the globalization data containing the translations for said screen, as well as the marketization data that determines its structure and styling, from a data store to said grc computer program residing on said computer that renders the page to said end users,
processing the source markup to separate the text to be translated from the markup defining said screen's design and structure,
processing the source markup to replace the said text with any translations to that text that were entered by a human being in a data management application and stored in a storage device,
transmitting said processed version of the source markup to the browser of the end user where the said computer program resides.

2. The method of claim 1, further comprising:
processing the source markup so as to replace any segments, including images with altered versions of those segments, or eliminate them, per the instructions associated with the segments and specified in said data management application.

3. The method of 1, wherein the display screen is a web page and the computer rendering the web page, on which the transformation program resides, is a web server.

4. The method of 1, wherein the display screen is a web page and the computer rendering the web page, on which the transformation program resides, is the end user's computer, on which the browser resides.

5. The method of 1, wherein the display screen is a web page from an html/web-based mobile application, viewed from a mobile device and the computer rendering the screen, on which the transformation computer program resides, is the web server.

6. The method of 1, wherein the display screen is a screen of a native mobile application, viewed from a mobile device and the computer rendering the screen, on which the transformation computer program resides, is the mobile device.

7. A method, performed by a set of computer programs, of rendering said web page directly editable within a browser, so that said web page can be transformed visually by a human being from its original state to a version displayed appropriately to an end user in another country and saved, the method comprising:
receiving the source markup for the web page by the grc program on a computer rendering a web page,
processing said source markup in such a way that client-side computer code is injected into the web page, by the grc computer program, along with styling directives, new markup, and previously saved globalization data as well as references to resources containing pre-written client-side code, stylesheets, data and markup,
creating by the injection and reference of these elements a new program within the web page which runs inside the browser, and at page load time attaches onhover or similar events to many elements on the page pointing to a routine that selects them visually when hovered over by a mouse cursor and stores them in memory upon clicking, and displaying edit boxes, menus and other user interface elements in appropriate locations after other user events such as double clicking or right clicking thereby providing the means to allow the elements in the page to be directly selected, edited and manipulated within a browser for a target language or country by a human being,
transmitting by said injected and referenced code the data representing the translations and edits made by said admin user to a set of application programming interfaces, or apis, on another computer hosted preferably by another party such as a globalization company,
receiving said data by the apis and transmitting them to a data store for long term storage.

8. The method of 7, where the grc computer program transforming
the source markup resides on a web server.

9. The method of 7, where the grc computer program transforming
the source markup resides on the end user's machine in which the browser resides, preferably as client-side code such as javascript referenced manually in the page.

10. The method of claim 7, further comprising:
processing the source markup to inject, through direct injection or injection of a reference to a resource, computer code that uploads an alternate image chosen by an admin user for a particular market, to a cloud storage or separate computing device.

11. The method of 8, where said grc computer program transforming the source markup resides on a web server.

12. The method of 9, where said grc computer program transforming the source markup resides on the end user's machine in which the browser resides, preferably by client-side code such as javascript referenced manually in said page.
